(19) United States
(12) Patent Application Publication
(10) Pub. No.: US 2007/0067082 A1
(43) Pub. Date: Mar. 22, 2007

(54) Integrated vehicle system

(75) Inventor: Russell Watts, Ann Arbor, MI (US)

Correspondence Address: MICHAEL BEST & FRIEDRICH LLP, 100 EAST WISCONSIN AVENUE, MILWAUKEE, WI, 53202, US

(73) Assignee: Robert Bosch GmbH

(21) Appl. No.: 11/230,998

(22) Filed: Sep. 20, 2005

(51) Int. Cl. G05D 1/00; G06F 17/00

(52) U.S. Cl. 701/45; 701/1

(57) ABSTRACT

An electronic control unit for a vehicle configured to control a first and at least a second vehicle function. The electronic control unit includes a first microcontroller that is configured to control the first vehicle function. The electronic control unit also includes at least a second microcontroller that is configured to control the at least second vehicle function. A communication system located within the electronic control unit transfers information between the first microcontroller and the at least second microcontroller.

### BACKGROUND

Embodiments of the invention relate to vehicle control systems. More specifically, embodiments relate to integrating microcontrollers or similar controllers of several vehicle systems.

There has been a proliferation of electronic control units (“ECUs”) in modern vehicles. There is an effort in place to reduce the number of ECUs by consolidation of multiple functions into fewer ECUs by combining functions in software. Combining functions in software, however, can rapidly increase the level of complexity and require that the fewer ECUs each have more computing resources and more complex processors that operate at higher data rates.

### SUMMARY

Instead of combining functions in software, another approach to reducing the number of ECUs is through standard interfaces between multiple, simpler controllers (i.e., modularization). Modularization can simplify development because there is less software code to manage and operate to achieve a function. Additionally, the software and resources for one function can change and evolve relatively independent of the other system functions.

In one embodiment, the invention provides an electronic control unit for a vehicle. The electronic control unit includes a first microcontroller located within the electronic control unit configured to control a first vehicle function. The first microcontroller communicates with a first set of vehicle sensors. A second microcontroller is located within the electronic control unit. The second microcontroller is configured to control a second vehicle function, and communicates with a second set of vehicle sensors. Additionally, a communication system is located within the electronic control unit and configured to transfer information between the first microcontroller and the second microcontroller. A shared operating system located within the electronic control unit is configured to control hardware and software components used by both the first microcontroller and the second microcontroller.

In another embodiment, the invention provides a method of controlling vehicle systems. The method includes determining a degree of coupling between a plurality of vehicle systems. The degree of coupling is determined by evaluating a measure of vehicle function interaction with respect to time, space, sharing of data, or a combination of the same. The method also includes integrating at least two microcontrollers into a single electronic control unit. The at least two microcontrollers are configured to control at least two of a plurality of vehicle systems. Additionally, information is exchanged between the at least two microcontrollers.

In yet another embodiment, a vehicle having a vehicle control system is provided. The vehicle control system includes an electronic control unit configured to have an occupant force sensing system and an air bag deployment system. A plurality of force sensors configured to measure a force (e.g., a weight) of an occupant of the vehicle is also included in the vehicle control system. An occupant classification microcontroller, located within one of the plurality of occupant force sensors, is used to control the occupant force sensing system. An air bag deployment microcontroller, located within the electronic control unit, is used to control the air bag deployment system and communicates with the occupant classification microcontroller.

In still another embodiment, an electronic control unit for a vehicle configured to control a first and at least a second vehicle function is provided. The electronic control unit includes a first microcontroller that is configured to control the first vehicle function and be in communication with a first set of vehicle sensors. The electronic control unit also includes at least a second microcontroller that is configured to control the at least second vehicle function and be in communication with a second set of vehicle sensors. A communication system located within the electronic control unit transfers information between the first microcontroller and the at least second microcontroller. A conditioned power supply supplies power to both the first microcontroller and the at least second microcontroller.

Other aspects of various embodiments will become apparent by consideration of the detailed description and accompanying drawings.

### BRIEF DESCRIPTION OF THE DRAWINGS

FIG. 1 is an illustration of a control system.

FIG. 2 is an illustration of an embodiment of a vehicle control system.

FIG. 3 is an illustration of an exemplary pair of ECUs within a vehicle control system.

FIG. 4 is a flow chart of a decision process.

FIG. 5 is an illustration of an embodiment of an integrated vehicle control system.

FIG. 6 is an illustration of another embodiment of an integrated vehicle control system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings, respectively.

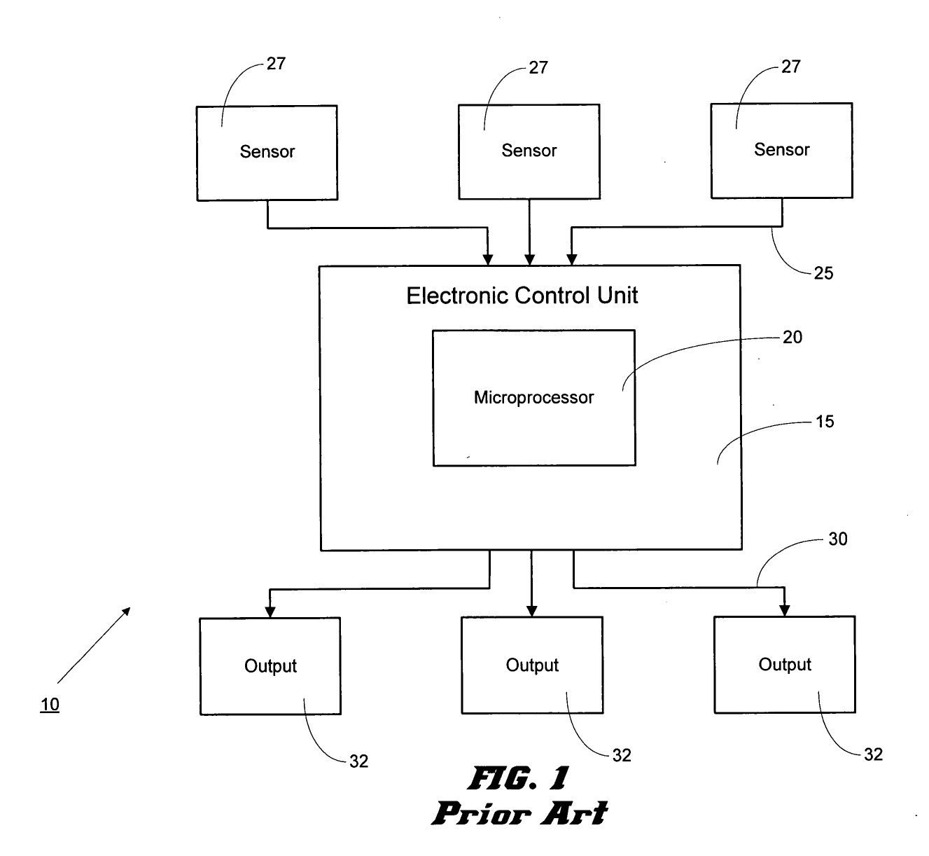

FIG. 1 illustrates a prior-art control system 10 having an ECU 15. The ECU 15 includes a microprocessor 20 that is used to process a plurality of input signals 25 from a plurality of sensors (represented by blocks 27) and transmit a plurality of output signals 30 to a plurality of output devices or functions (represented by blocks 32). The microprocessor 20 can include software (not shown) that controls the reception of the plurality of input signals 25 as well as the transmission of the plurality of output signals 30. As the number of input signals 25 and output signals 30 increases, the software used by the microprocessor 20 gets increasingly complex. Additional memory (not shown) is also required as the number of input signals 25 and output signals 30 is increased.

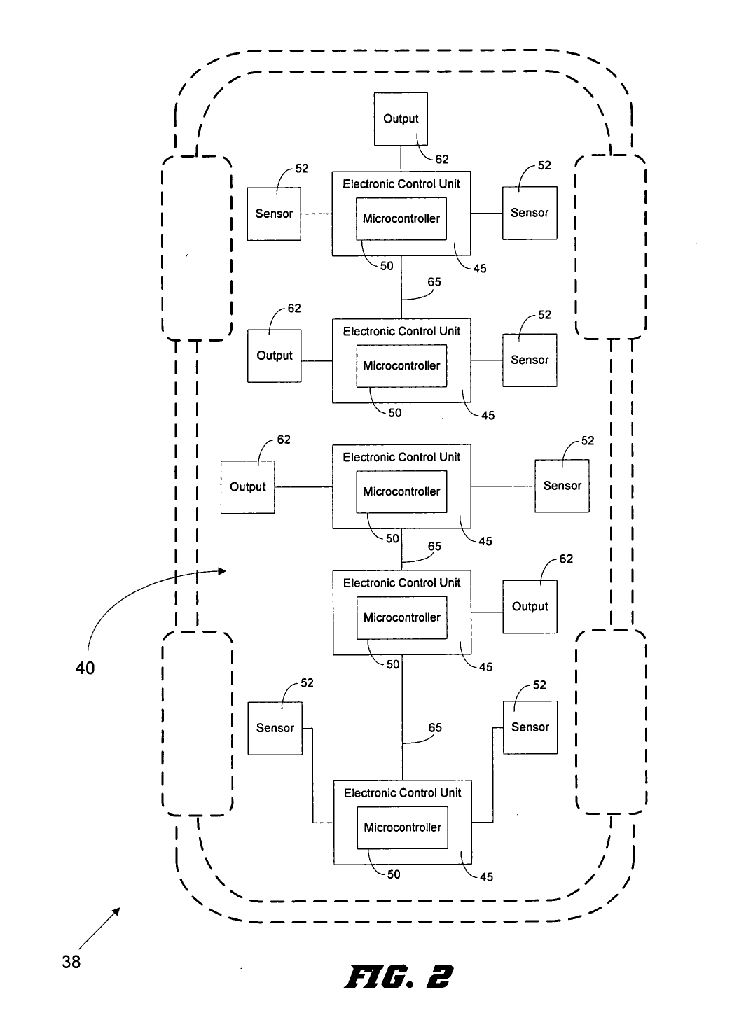

FIG. 2 illustrates a vehicle 38 having a control system 40. The control system 40 includes a plurality of ECUs 45, and each of the ECUs 45 includes a microcontroller 50. It should be understood that “microcontroller” can mean an integrated circuit that contains components comprising a controller, which can include a central processing unit (“CPU”), memory, input/output (“I/O”) ports, and timers. In other embodiments, however, a variety of other controllers and processors could be used. For example, each ECU could have controllers that are realized using a variety of known devices, including microprocessors, programmable logic arrays, and other similar devices. Additionally, the ECUs 45 can include memory, input/output (“I/O”) interfaces, power supplies, power conditioners, housings, hardware mountings, and fault detection systems external to the microcontroller (all not shown). The ECUs 45 receive information from a plurality of input sensors 52 and transmit processed data to outputs 62. Each output 62 can take the form of a variety of things, for example, a vehicle mechanism (e.g., an air bag actuator), or signals (e.g., a “check engine” light signal). Therefore, the ECUs 45, input sensors 52, and outputs 62 can all be used to control a vehicle system (e.g., an air bag system, an occupant force system, an anti-lock brake system, etc.). For example, an antilock brake ECU can process data collected from wheel sensors in a microprocessor. The microprocessor can then activate an antilock brake function using an output signal. For those systems that share data (e.g., occupant force system and air bag system) a communication link 65 can be used to transfer data between systems. Both wired and wireless communication links can be used.

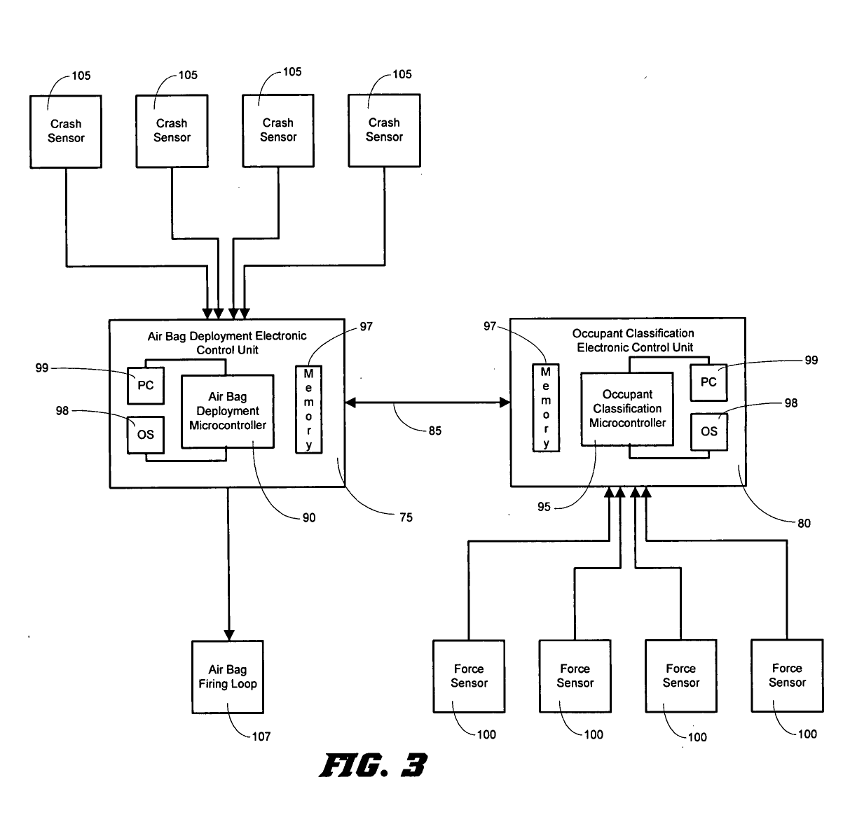

An exemplary pair of ECUs 45 that are in communication with each other is shown in FIG. 3. An air bag deployment ECU 75 is connected to an occupant classification ECU 80 via a link 85. In the embodiment shown, the air bag deployment ECU 75 includes an air bag deployment microcontroller 90, and the occupant classification ECU 80 includes an occupant classification microcontroller 95. A memory 97 (e.g., a random access memory (“RAM”), read only memory (“ROM”), erasable-and-programmable ROM (“EPROM”), etc.), an operating system 98, and a power conditioning system 99 are also included in each of the ECUs 75 and 80. Additionally, each of the ECUs 75 and 80 can include additional hardware such as a motherboard, I/O interfaces, connectors, etc. The air bag deployment ECU 75 can also utilize data from the occupant classification ECU 80 via the link 85. The link 85 may require a special I/O interface (not shown) to connect to both of the ECUs 75 and 80.

Still referring to FIG. 3, the occupant classification microcontroller 95 is used to process data collected by force sensors 100. In some embodiments, the force sensors 100 are configured to transmit a signal to the occupant classification microcontroller 95 indicative of a weight of an occupant in the vehicle. The force sensors 100 can be sensitive to the direction of weight. The occupant classification microcontroller 95, therefore, can use the signals from the force sensors 100 to determine a weight measurement, position, and classification of the occupant in a vehicle. In one embodiment, the occupant classification microcontroller 95 “polls” or requests information from each of the plurality of force sensors 100. Because the weight and position of the occupant can change relatively slowly over time, the force sensors 100 can be polled (and respond by transmitting a signal to the occupant classification microcontroller 95) with a relatively slow cycle speed (e.g., approximately 3-5 seconds). Alternatively, the force sensors 100 can be configured to transmit force signals to the occupant classification microcontroller 95 automatically (i.e., without being polled) and with varying intervals (e.g., half of a second, one second, ten seconds, etc.), depending on the system requirements.

As previously described, the data collected by the force sensors 100 and processed by the occupant classification microcontroller 95 is passed from the occupant classification ECU 80 to the air bag deployment ECU 75 via the link 85. The data from the occupant classification ECU 80 can then be used by the air bag deployment microcontroller 90 to make an air bag deployment decision (i.e., deploy the air bag or do not deploy the air bag). Data from a plurality of crash sensors 105 is used by the air bag microcontroller 90 to determine the air bag deployment decision. The air bag is deployed by the air bag ECU 75 using the air bag firing loop output 107. The plurality of crash sensors 105 can be positioned at various locations around the vehicle and transmit a signal indicative of a vehicle crash (e.g., an accident) to the air bag microcontroller 90. The plurality of crash sensors 105 can transmit data to the air bag deployment microcontroller 90 in a manner that is similar to how the occupant force sensors 100, described above, transfer information (e.g., by being polled by the air bag microcontroller 90 or automatically transmitting a signal). The two ECUs 75 and 80 shown can include a variety of redundant hardware and software. For example, each of the microcontrollers 90 and 95 may be mounted on its own motherboard. The ECUs 75 and 80 may each include a distinct memory 97, operating system 98, and power conditioning system 99. Additionally, interface connections (e.g., I/O), fault detection systems, and hardware mounts can also all be redundant.

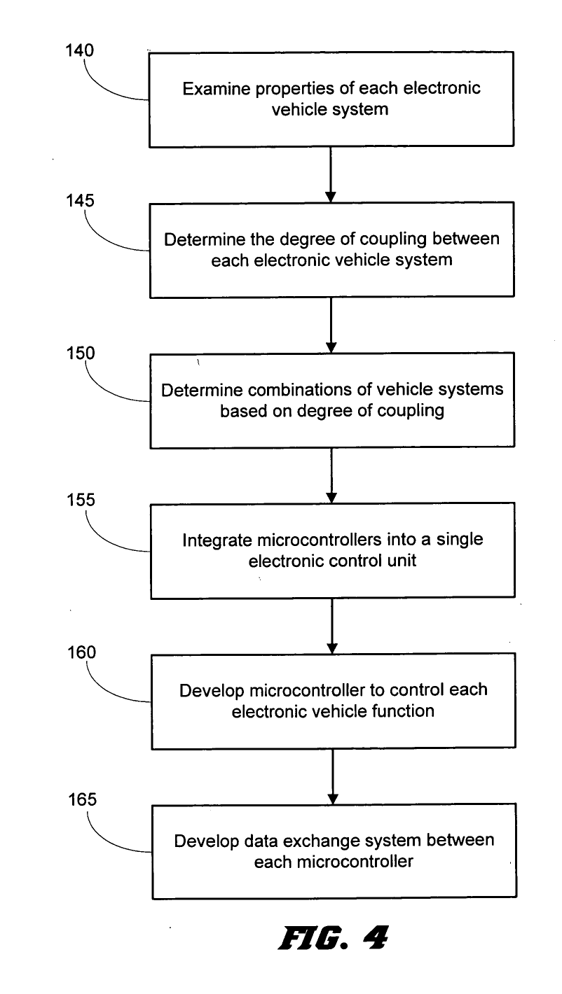

To avoid such redundancies, several vehicle system microcontrollers can be combined or integrated into a single ECU. To determine which vehicle system microcontrollers to integrate, several factors of the microcontrollers can be taken into consideration. FIG. 4 illustrates an example decision process that aids in integrating microcontrollers of various vehicle systems into a single ECU. First, the properties of each vehicle system are examined and categorized (block 140). For example, properties or parameters of a vehicle system can include time, space, and data relationships. The time parameter can correspond to the transmission cycle of input sensors (e.g., force sensors transmitting a signal every 3 seconds). In another embodiment, the time parameter can refer to the polling cycle time of the microcontroller. The space parameter can correspond to the location of one vehicle system with respect to another. Data used or shared by a microcontroller can be a main data parameter determinant.

After examining each of the parameters of the vehicle systems, a degree of coupling between each vehicle system is determined (block 145). Vehicle systems are considered to be tightly coupled in time if functions of the vehicle system interact strongly in time with one another (e.g., sensors are polled at the same time; decisions are made with the same frequency, etc.). Vehicle systems can be considered loosely coupled if functions occur with substantially different timing requirements (e.g., one microcontroller with a polling cycle of 20 microseconds and another microcontroller with a polling cycle of 3 seconds). The relative position of components of a vehicle system can also help determine the degree of coupling between vehicle systems. For example, engine control systems that are located in the engine compartment (under the hood of the vehicle) can be considered tightly coupled in position. On the other hand, components of an antilock brake system and an air bag system can be positioned relatively far from each other and can, therefore, be considered to be loosely coupled with respect to position. Additionally, the amount of data shared between vehicle systems can be used to determine a degree of coupling between vehicle systems. For example, an antilock brake system and a traction control system may need to share a large amount of data (e.g., wheel slip, wheel speed, etc.) and can, therefore, be considered to be tightly coupled with respect to the sharing of data. Certain vehicle systems may not share any data. Therefore, those systems can be considered to be loosely coupled with respect to the sharing of data.

Vehicle systems that have relatively significant coupling combinations are determined (block 150) after the degree of coupling between each vehicle system is evaluated (block 145). Coupling combinations can be determined by considering each vehicle system's time, space, and data parameters. For example, the vehicle systems that are in close proximity to one another, but operate with a substantially different polling frequency may be considered to be a favorable combination. Additionally, vehicle systems that share data to make decisions may also be considered to be a favorable combination. Of course, other factors (e.g., size of ECU, cost of hardware and software, etc.) can also play a role in determining which vehicle systems to combine.

Integration of more than one microcontroller in a single ECU (block 155) can begin after the coupling combinations are developed. Combining more than one microcontroller into a single ECU can reduce the redundancies found in vehicle systems with multiple ECUs (as described with respect to FIGS. 2-3). Additionally, a single ECU system with multiple controllers can reduce the overall software complexity needed to perform the functions of the vehicle systems, unlike the relatively complex software system required by the embodiment shown in FIG. 1. After integration of the microcontrollers into a single ECU, each microcontroller can be developed separately to control its corresponding vehicle system (block 160). This separate, “modular” approach allows software to be programmed and contained within each microcontroller independently. In doing so, each vehicle system can be altered (by altering the software programmed into the microcontroller) with few of the other vehicle systems being affected. A data exchange system can also be developed in the ECU (block 165) that can be used to transmit data from one integrated microcontroller to another.

Referring again to the embodiment shown in FIG. 3, the occupant classification ECU 80 generally gathers information and forms an occupant measurement and classification, and transmits that occupant information to the air bag deployment ECU 75. The air bag deployment ECU 75 then makes an air bag deployment decision. In that embodiment, the occupant classification ECU 80 exchanges information with the air bag deployment ECU 75, and has limited use elsewhere in the vehicle. The two ECUs 75 and 80 share a space and data relationship but are only loosely coupled with respect to time. For example, the ECUs 75 and 80 can both be used to control vehicle systems that are in generally the same area of the vehicle (i.e., the steering wheel and the seat). Further, the air bag deployment ECU 75 at least partially bases the deployment decision on information provided by the force sensors 100 (through the occupant classification ECU 80). The air bag deployment ECU 75, however, generally has a polling or clock cycle of a fraction of a second, whereas the occupant classification ECU 80 has a polling rate or clock cycle that is slower. Therefore, according to the process described with respect to FIG. 4, the microcontrollers of each system can be combined into one ECU.

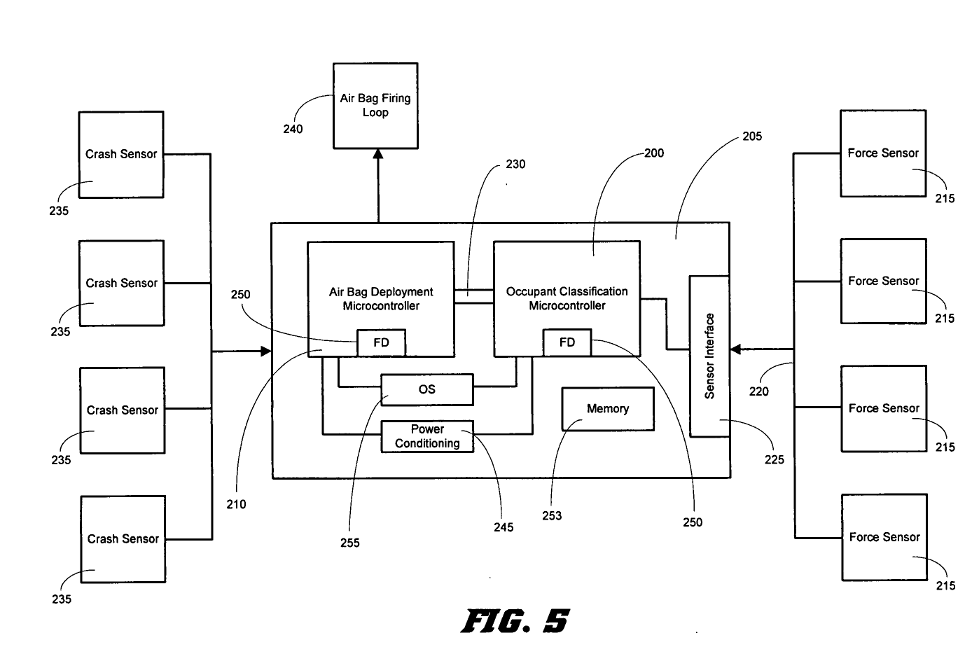

FIG. 5 illustrates one embodiment of an ECU having more than one integrated microcontroller. In the embodiment shown, an occupant classification microcontroller 200 is integrated into an air bag deployment ECU 205, which has an air bag deployment microcontroller 210. A plurality of force sensors 215 are used to gather weight information of an occupant in a vehicle (not shown). The force data is transmitted to the occupant classification microcontroller 200 via links 220. The links can be a common bus or other similar information system. In some embodiments, the signals that are transmitted from the plurality of force sensors 215 are first received by a sensor interface 225, and then transferred from the sensor interface 225 to the occupant classification microcontroller 200. The processed weight and position information gathered by the force sensors 215 is transferred from the occupant classification microcontroller 200 to the air bag deployment microcontroller 210 via link 230. The air bag microcontroller 210 can also receive data from a plurality of crash sensors 235. The air bag microcontroller 210 can use the data received from the crash sensors 235 and the data from the occupant classification microcontroller 200 to make an air bag deployment decision. If the decision is made to deploy an airbag (or a plurality of airbags), an air bag firing loop 240 can be activated by the air bag deployment microcontroller 210.

In one embodiment, the link 230 is a trace, or plurality of traces, that is/are embedded in a substrate and integrated into the ECU 205 to electrically connect the ECUs 200 and 210. Configuring the link 230 in this manner helps reduce the need for a cable or other external connection device to be connected between the two ECUs 200 and 210. In other embodiments, the link 230 that is used to electrically connect the ECUs 200 and 210 can be an external wire, a wireless communication mechanism, or other communication mechanism. A power conditioning system 245 can be used to supply both microcontrollers 200 and 210 with power or a conditioned power signal (e.g., a 24 volt, DC signal). A fault detection system 250 (e.g., a watchdog timer) can be included in each microcontroller 200 and 210 and communicate via the integrated link 230. A memory 253 (e.g., RAM) and an operating system (represented by 255) can also be included in the ECU 205 and be shared by each microcontroller 200 and 210. The operating system is used as a platform for the software of each microcontroller 200 and 210. Additionally, the code (i.e., software) of each microcontroller 200 and 210 can be made less complex than if both functions were controlled by the same microcontroller (as shown and described in FIG. 1).

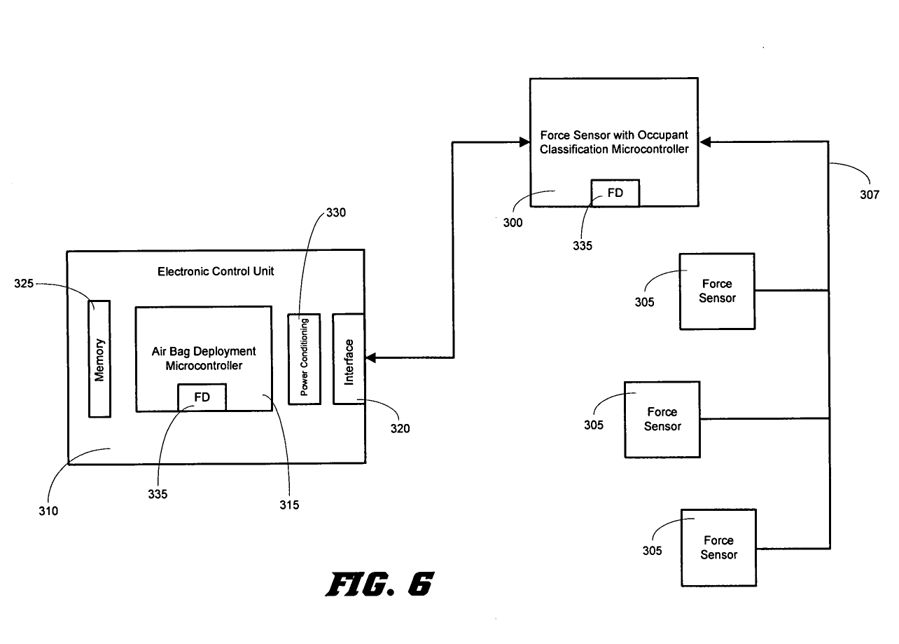

In another embodiment, the occupant classification microcontroller 200 is combined with a force sensor 215 to produce a “super sensor” 300, shown in FIG. 6. The super sensor 300 receives weight and position data from a plurality of force sensors 305, and uses the data to determine an occupant classification. The force sensors 305 can be linked with a common bus 307. The common bus 307 may be private, specifically designated to the occupant force sensing system, or public so that data from the air bag deployment system (with associated crash sensors) can also be transferred on it. Occupant measurement and classification information is transmitted from the super sensor 300 to an air bag deployment ECU 310, and used by an air bag deployment microcontroller 315. In some embodiments, the measurement and classification data from the super sensor 300 is first received by an interface 320 in the air bag ECU 310 before being transmitted to the air bag deployment microcontroller 315. Components such as a memory 325 (e.g., RAM, EPROM, flash, and the like), a power conditioning system 330, and a fault detection system 335 can also be included in the air bag deployment ECU 310. Another fault detection system 335 can be included in the super sensor 300, and be in communication with the fault detection system 335 of the air bag deployment microcontroller 315.

As should be apparent to one of ordinary skill in the art, the systems shown in the figures are models of what actual systems might be like. Many of the components and logical structures described are capable of being implemented in software executed by a microprocessor or a similar device or of being implemented in hardware using a variety of components including, for example, application specific integrated circuits (“ASICs”). Thus, the claims should not be limited to the specific examples provided herein.

Various features and aspects of the invention are set forth in the following claims.

What is claimed is:

1. An electronic control unit for a vehicle, the electronic control unit comprising:
a first microcontroller located within the electronic control unit and configured to control a first vehicle function and be in communication with a first set of vehicle sensors;
a second microcontroller located within the electronic control unit and configured to control a second vehicle function and be in communication with a second set of vehicle sensors;
a communication system located within the electronic control unit and configured to transfer information between the first microcontroller and the second microcontroller; and
a shared operating system located within the electronic control unit and configured to control hardware and software components used by both the first microcontroller and the second microcontroller.

2. The electronic control unit of claim 1, wherein the first function includes determining an occupant force and the second function includes controlling an air bag deployment.

3. The electronic control unit of claim 1, further comprising at least one memory module configured to store data for both the first function and the second function.

4. The electronic control unit of claim 1, further comprising a first fault detection system and a second fault detection system, wherein the first fault detection system is a function of the first microcontroller and the second fault detection system is a function of the second microcontroller, and the first and second fault detection systems are in communication with each other.

5. The electronic control unit of claim 4, wherein the first and second fault detection systems each include at least one watch dog timer.

6. The electronic control unit of claim 1, further configured to include an external communication interface wherein the external communication interface is configured to communicate with both the first and second sets of sensors and both the first and second microcontrollers.

7. The electronic control unit of claim 1, further comprising a power conditioning system configured to supply power to both the first and the second microcontrollers.

8. The electronic control unit of claim 1, wherein the first and second microcontrollers share a degree of coupling based on a measure of vehicle function interaction with respect to time, space, sharing of data, or a combination of the same.

9. A method of controlling vehicle systems comprising:
determining a degree of coupling between a plurality of vehicle systems, wherein the degree of coupling is determined by evaluating a measure of vehicle function interaction with respect to time, space, sharing of data, or a combination of the same;
integrating at least two microcontrollers into a single electronic control unit, wherein the at least two microcontrollers are configured to control at least two of a plurality of vehicle systems; and
configuring the at least two microcontrollers to exchange information with each other.

10. The method according to claim 9, wherein integrating the at least two microcontrollers includes integrating an occupant classification microcontroller and an air bag deployment microcontroller.

11. The method according to claim 9, further comprising integrating a memory module into the electronic control unit that is accessed by the at least two microcontrollers.

12. The method according to claim 9, further comprising detecting a fault with a fault detection system, wherein the fault detection system includes a watch dog timer.

13. The method according to claim 12, wherein detecting a fault includes communicating between the at least two microcontrollers.

14. The method according to claim 9, further comprising supplying power to the at least two microcontrollers with a power conditioning system.

15. A vehicle having a vehicle control system, the vehicle control system comprising:
an electronic control unit configured to include an occupant force sensing system and an air bag deployment system;
a plurality of force sensors configured to measure a weight and a position of an occupant of the vehicle;
an occupant classification microcontroller located within one of the plurality of occupant force sensors and configured to control the occupant force sensing system; and
an air bag deployment microcontroller located within the electronic control unit and configured to control the air bag deployment system and communicate with the occupant classification microcontroller.

16. The vehicle control system of claim 15, further comprising at least one memory module configured to store data for both the occupant classification microcontroller and the air bag deployment microcontroller.

17. The vehicle control system of claim 15, further comprising a first fault detection system and a second fault detection system, wherein the first fault detection system is a function of the occupant classification microcontroller and the second fault detection system is a function of the air bag deployment microcontroller, and the first and second fault detection systems are in communication with each other.

18. The vehicle control system of claim 17, wherein each of the first and second fault detection systems include a watch dog timer.

19. The vehicle control system of claim 15, further comprising a power conditioning system configured to supply power to both the occupant classification microcontroller and the air bag deployment microcontroller.

20. An electronic control unit for a vehicle configured to control a first and at least a second vehicle function, the electronic control unit comprising:
a first microcontroller configured to control the first vehicle function and be in communication with a first set of vehicle sensors;
at least a second microcontroller configured to control the at least second vehicle function and be in communication with at least a second set of vehicle sensors;
a communication system located within the electronic control unit and configured to transfer information between the first microcontroller and the at least second microcontroller; and
a power supply configured to supply power to both the first microcontroller and the at least second microcontroller.

21. The electronic control unit of claim 20, wherein the communication system is comprised of a substrate that includes a plurality of electrically conductive traces.

22. The electronic control unit of claim 20, wherein the first microcontroller is located within one of the first set of vehicle sensors.

23. The electronic control unit of claim 20, wherein the first function is determining an occupant force and the second function is controlling an air bag deployment.

24. The electronic control unit of claim 20, further comprising at least one memory module configured to store data for the first microcontroller and the second microcontroller.

25. The electronic control unit of claim 20, further comprising a first fault and at least a second fault detection system, wherein the first fault detection system is a function of the first microcontroller and the at least second fault detection system is a function of the at least second controller, and the first and second fault detection systems are in communication with each other.

26. The electronic control unit of claim 25, wherein each of the first and second fault detection systems include a watch dog timer.

27. The electronic control unit of claim 20, wherein the first and the at least second microcontroller share a degree of coupling based on a measure of vehicle function interaction with respect to time, space, sharing of data, or a combination of the same.
